(19) United States
(12) Patent Application Publication
(10) Pub. No.: US 2025/0381785 A1
(43) Pub. Date: Dec. 18, 2025

(54) CONVEYANCE DEVICE, IMAGE FORMING APPARATUS AND COMPUTER-READABLE MEDIUM

(71) Applicant: Konica Minolta, Inc., Tokyo (JP)

(72) Inventor: Takahiro HARA, Tokyo (JP)

(21) Appl. No.: 19/238,036

(22) Filed: Jun. 13, 2025

(30) Foreign Application Priority Data
Jun. 13, 2024 (JP) 2024-095520

(51) Int. Cl. B41J 13/22; B41J 13/00

(52) U.S. Cl. CPC B41J 13/226; B41J 13/0027

(57) ABSTRACT

Disclosed is a conveyance device including: a conveyance section that conveys a recording medium; an air channel that communicates between a suction hole provided on a conveyance surface of the conveyance section and a suction section that suctions air; a valve that divides the air channel into an open space containing the suction hole and a closed space containing the suction section when the valve is closed; and a hardware processor that controls attachment of the recording medium onto the conveyance surface. The hardware processor opens the valve when the recording medium blocks the suction hole.

### CROSS REFERENCE TO RELATED APPLICATIONS

The present invention claims priority under 35 U.S.C. § 119 to Japanese Application No. 2024-095520, filed on Jun. 13, 2024, the entire contents of which being incorporated herein by reference.

### BACKGROUND OF THE INVENTION

### Technical Field

The present invention relates to a conveyance device, an image forming apparatus, and a computer-readable medium.

### Description of Related Art

Conventionally, there has been known an image forming apparatus that forms an image on a recording medium conveyed by a conveyance section. The conveyance section includes, for example, a conveyance cylinder that rotates while attaching the recording medium onto a conveyance surface thereof. The conveyance cylinder is connected to a negative pressure source that suctions air and attaches the recording medium onto the conveyance surface by suctioning the air through suction holes provided on the conveyance surface.

In such a conveyance section, a weak suction force causes the recording medium to lift, resulting in a conveyance failure or a printing failure. Therefore, for example, JP 2013-241272A describes a configuration in which connection to a negative pressure source is switched in accordance with the rotation of a conveyance cylinder to continuously attach a recording medium from the front end to the rear end of the recording medium.

### SUMMARY OF THE INVENTION

However, in the above-described configuration, since suction holes are opened to the atmosphere when no recording medium is placed on the conveyance surface, the suction force is insufficient at the start of a print job. On the other hand, increasing the suction force to prevent this problem may cause a wrinkle to form on the recording medium.

The present invention has been made in view of such circumstances. It is an object of the present invention to provide a conveyance device, an image forming apparatus, and a computer-readable medium capable of instantaneously attaching and conveying a recording medium with a suitable suction force.

To achieve at least one of the abovementioned objects, a conveyance device reflecting one aspect of the present invention comprises: a conveyance section that conveys a recording medium; an air channel that communicates between a suction hole provided on a conveyance surface of the conveyance section and a suction section that suctions air; a valve that divides the air channel into an open space containing the suction hole and a closed space containing the suction section when the valve is closed; and a hardware processor that controls attachment of the recording medium onto the conveyance surface, wherein the hardware processor opens the valve when the recording medium blocks the suction hole.

To achieve at least one of the abovementioned objects, an image forming apparatus reflecting another aspect of the present invention comprises: the conveyance device described above; and an image forming section that forms an image on the recording medium.

To achieve at least one of the abovementioned objects, a computer-readable medium reflecting still another aspect of the present invention is a non-transitory computer-readable medium storing a computer-executable program, the program causing a computer of a conveyance device that includes: a conveyance section that conveys a recording medium; an air channel that communicates between a suction hole provided on a conveyance surface of the conveyance section and a suction section that suctions air; and a valve that divides, when the valve is closed, the air channel into an open space containing the suction hole and a closed space containing the suction section to execute controlling attachment of the recording medium onto the conveyance surface, wherein the controlling includes opening the valve when the recording medium blocks the suction hole.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention, wherein:

FIG. 1 is a schematic side cross-sectional view of components constituting an image forming apparatus;

FIG. 2 is a block diagram illustrating the image forming apparatus according to an embodiment;

FIG. 3 is a cross-sectional view in a width direction illustrating a configuration of an interior and a surrounding of a conveyance section according to the embodiment;

FIG. 4 is a cross-sectional view in a conveyance direction illustrating an configuration of the interior and the surrounding of the conveyance section according to the embodiment;

FIG. 5 is a perspective view illustrating a configuration around the conveyance section according to the embodiment;

FIG. 6 is a graph summarizing recording media placed respectively on conveyance surfaces in a conventional image forming apparatus from the start of single-sided printing and suction pressures;

FIG. 7 is a graph summarizing recording media placed respectively on conveyance surfaces in the image forming apparatus according to the embodiment from the start of single-sided printing and suction pressures;

FIG. 8 is a graph summarizing recording media placed respectively on conveyance surfaces in a conventional image forming apparatus from the start of double-sided printing and suction pressures; and

FIG. 9 is a graph summarizing recording media placed respectively on conveyance surfaces in the image forming apparatus according to the embodiment from the start of double-sided printing and suction pressures.

### DETAILED DESCRIPTION

Hereinafter, one or more embodiments of the present invention will be described with reference to the drawings. However, the scope of the invention is not limited to the disclosed embodiments. In the following description, components having the same function and configurations are denoted by the same reference numerals, and the description thereof will be omitted.

### [Overall Configuration of Image Forming Apparatus]

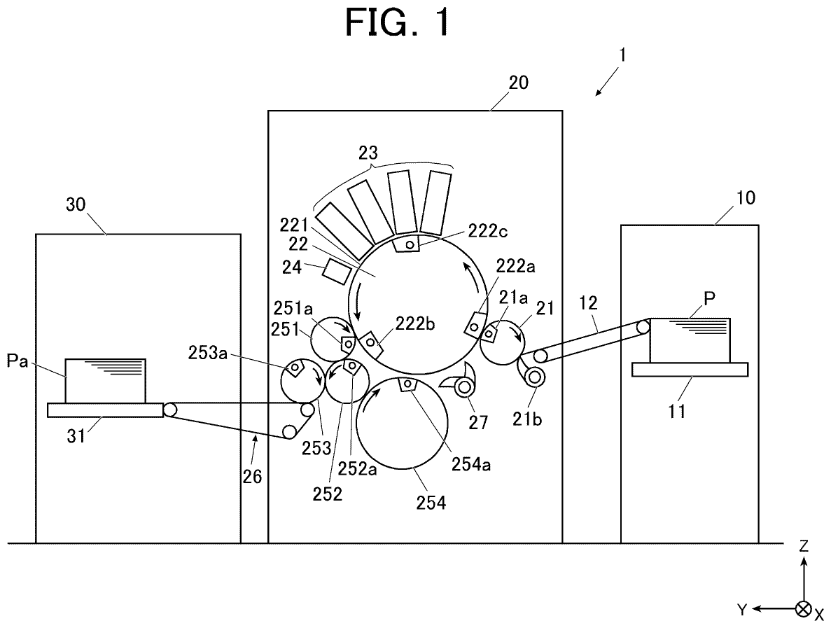

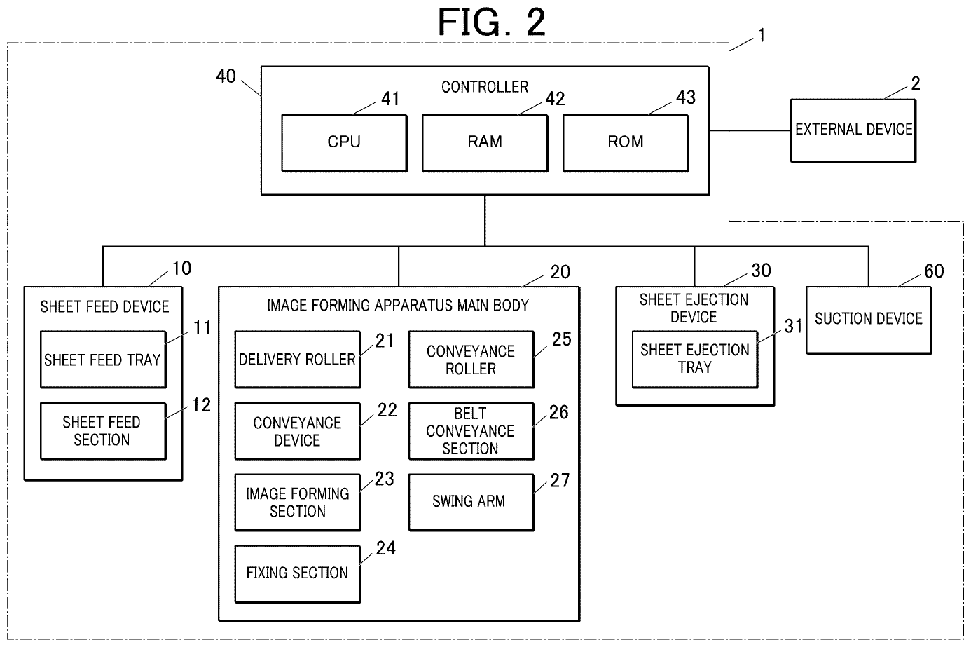

FIG. 1 is a diagram illustrating a schematic configuration of an image forming apparatus 1. FIG. 2 is a block diagram illustrating a functional configuration of the image forming apparatus 1. The image forming apparatus 1 includes a sheet feed device 10, an image forming apparatus main body 20, a sheet ejection device 30, and a controller 40 (hardware processor).

Note that in the following, an X direction, a Y direction, and a Z direction are directions illustrated in FIG. 1. In the following description, the X direction, the Y direction, and the Z direction are also referred to as a width direction, a conveyance direction, and a height direction, respectively.

### (Sheet Feed Device)

The sheet feed device 10 includes a sheet feed tray 11 and a sheet feed section 12. The sheet feed tray 11 stores recording media P. The sheet feed section 12 includes rollers and a belt. The belt has a ring shape, and an inner side of the belt is supported by two rollers. The sheet feed section 12 conveys a recording medium P in the conveyance direction by rotating the two rollers with the recording medium P placed on the belt.

### (Image Forming Apparatus Main Body)

The image forming apparatus main body 20 includes a delivery roller 21, a conveyance device 22, an image forming section 23, a fixing section 24, a conveyance roller 25, a belt conveyance section 26, and a swing arm 27.

### {Delivery Roller}

The delivery roller 21 is disposed at a position between the sheet feed section 12 and the conveyance device 22. The delivery roller 21 includes a claw 21a. The claw 21a is switched between an open state and a closed state under the control of the controller 40. The claw 21a enables the delivery roller 21 to hold the recording medium P on the conveyance surface thereof.

The delivery roller 21 delivers the recording medium P conveyed by the sheet feed section 12 to the conveyance device 22. Specifically, the delivery roller 21 holds and picks up a first end of the recording medium P conveyed from the sheet feed section 12 with a swing arm 21b and holds the first end with the claw 21a. Then, the delivery roller 21 rotates in a clockwise direction indicated by an arrow in FIG. 1 to deliver the recording medium P to any one of claws 222a to 222c of the conveyance device 22.

### {Conveyance Device}

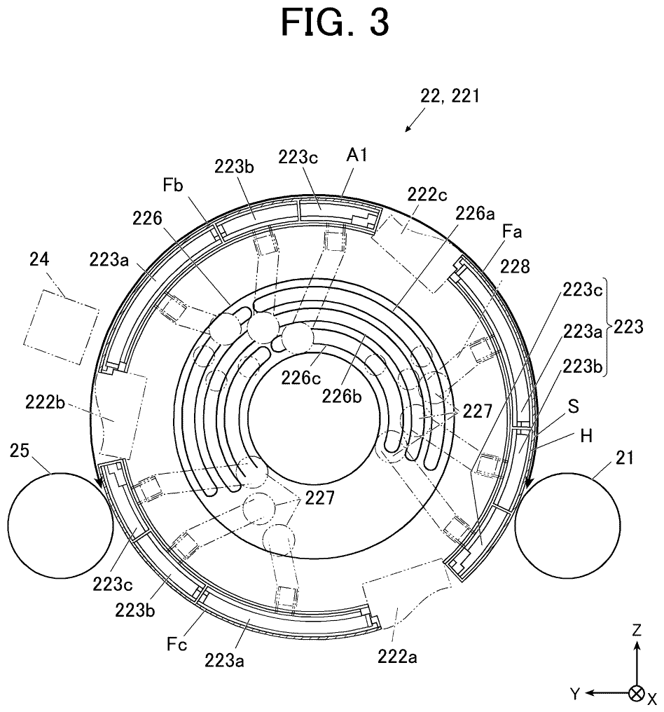

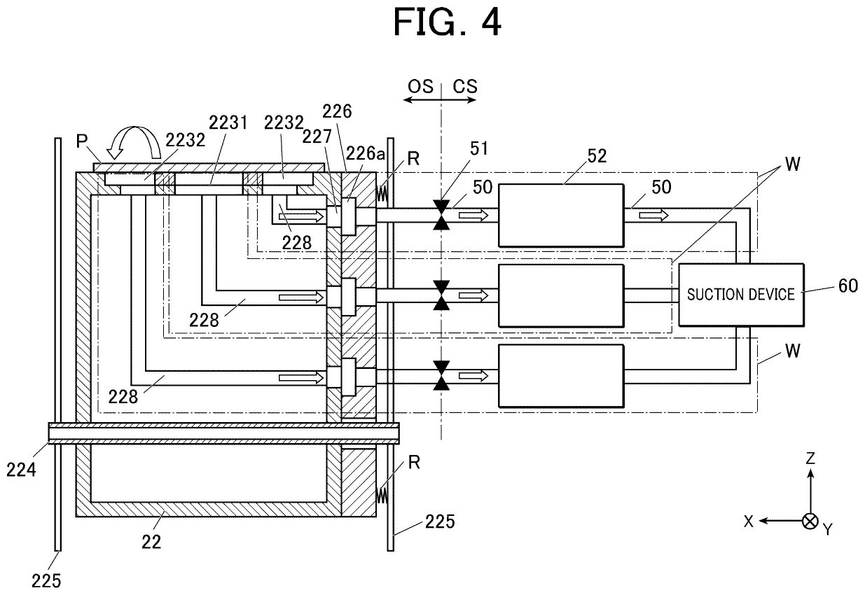

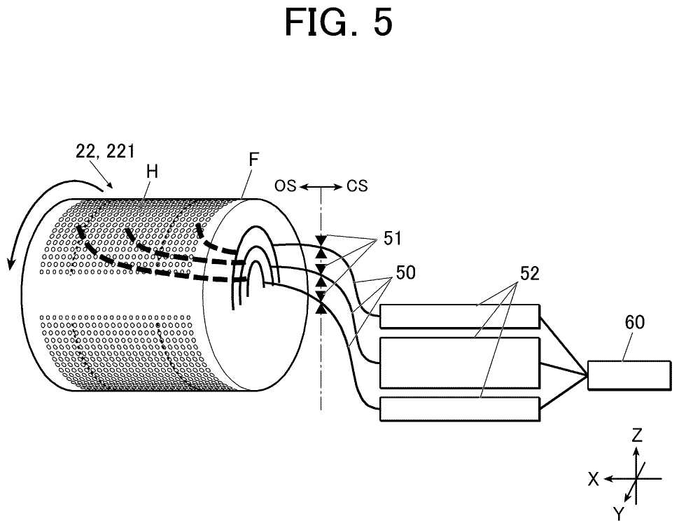

FIG. 3 is a cross-sectional view in the width direction illustrating a configuration of an interior and surroundings of the conveyance device 22. FIG. 4 is a cross-sectional view in the conveyance direction illustrating the configuration of the interior and the surroundings of the conveyance device 22. FIG. 5 is a perspective view illustrating a configuration around the conveyance device 22. Note that in FIG. 3, for illustrative purposes, the conveyance device 22 is illustrated on a larger scale than the delivery roller 21 and the conveyance roller 25. Further, in FIG. 4 and FIG. 5, air channels W (described later) corresponding to only three regions in the width direction are illustrated for simplicity. The conveyance device 22 conveys the recording medium P delivered from the delivery roller 21 in the conveyance direction indicated by an arrow in FIG. 1. The conveyance device 22 includes a conveyance drum 221.

### <Conveyance Drum>

The conveyance drum 221 serves as a conveyance section that conveys the recording medium P. The conveyance drum 221 includes, on an outer periphery thereof, a plurality of conveyance surfaces F. The recording medium P of a single sheet is placed on each of the plurality of conveyance surfaces F. The conveyance drum 221 has a cylindrical outline extending in the width direction and is connected to a conveyance drum motor (not illustrated). The controller 40 rotationally drives the conveyance drum motor to rotate the conveyance drum 221 by an angle proportional to the rotation amount. Under the control of the controller 40, the conveyance drum 221 conveys the recording medium P in the conveyance direction with the recording medium P facing the image forming section 23.

In the present embodiment, a case where the conveyance drum 221 is a triple drum (cylinder) is exemplified. A triple drum means that the circumferential length of the conveyance drum 221 is a size capable of simultaneously holding the recording media P of three sheets each having the maximum length usable in the image forming apparatus 1. That is, in the present embodiment, the conveyance drum 221 includes three conveyance surfaces F. Hereinafter, the three conveyance surfaces F are referred to as a surface A Fa, a surface B Fb, and a surface C Fc. Note that the conveyance drum 221 is not limited to a triple drum. The conveyance drum 221 may be, for example, a quadruple or quintuple drum.

### <Claws>

The conveyance drum 221 includes claws 222. The claws 222 are disposed on the surface A Fa, the surface B Fb, and the surface C Fc, one on each, at an interval equal to the circumferential length of the delivery roller 21 and the circumferential length of the conveyance roller 25. Each of the claws 222 is switched between an open state and a closed state under the control of the controller 40. In the closed state, each of the claws 222 presses the first end of the recording medium P in the conveyance direction delivered from the delivery roller 21 or the swing arm 27 with a predetermined pressing force to hold the recording medium P on the corresponding conveyance surface F. In addition, in the open state, the claw 222 is released from the above-described pressing state to deliver the recording medium P held on the conveyance surface F to the conveyance roller 25.

### <Chambers>

As illustrated in FIG. 3 and FIG. 4, the interior of the conveyance drum 221 has a hollow structure, and a chamber 223 is disposed below each of the surface A Fa to the surface C Fc (on the side facing the interior). A sheet S is disposed on each of the conveyance surfaces F and forms an outer surface of the chambers 223. A plurality of suction holes His formed on the sheet S.

As illustrated in FIG. 3, three chambers 223 (223a to 223c) are aligned between two of the claws 222 of the conveyance drum 221. Of these, the leading chamber 223a in the conveyance direction has the longest length in the conveyance direction. The length of the chamber 223a in the conveyance direction corresponds to the minimum length of the recording medium P in the conveyance direction that can be used in the image forming apparatus 1.

Furthermore, as illustrated in FIG. 4, the chambers 223a to 223c are provided so as to divide each conveyance surface F into a plurality of regions in the width direction. Hereinafter, among the chambers 223, the chamber 223 corresponding to the center of the placed recording medium P in the width direction is referred to as a center chamber 2231, and the chambers 223 other than the center chamber 2231 are referred to as end chambers 2232 (see FIG. 4 for both), for convenience. Although FIG. 4 and FIG. 5 illustrate the case where the center chamber 2231 is wider than the end chambers 2232, the center chamber 2231 and the end chambers 2232 may have the same width. Further, the number of regions of each conveyance surface F in the width direction is not limited to three.

As described above, in the present embodiment, the conveyance drum 221 includes (3 (maximum number of sheets simultaneously held by the conveyance drum 221)× 3 (number of chambers in the conveyance direction)× 3 (number of chambers in the width direction)=) 27 chambers 223. The conveyance surfaces F of the conveyance drum 221 includes 27 regions corresponding to these chambers 223.

### <Rotation Shaft, Side Plates, and Suction Control Plate>

As illustrated in FIG. 4, side plates 225 that hold a rotation shaft 224 of the conveyance drum 221 are disposed on the front and back sides of the conveyance drum 221 in the width direction. Between the side plate 225 on the front side and the conveyance drum 221, a substantially annular suction control plate 226 is disposed non-rotatably. Specifically, for example, as illustrated in FIG. 4, the suction control plate 226 is biased toward the conveyance device 22 by springs R disposed between the suction control plate 226 and the side plate 225.

As illustrated in FIG. 3, in the suction control plate 226, openings 226a to 226c are provided at positions corresponding to a suction region A1 in which the recording medium P is sucked by a suction device 60 described later. Each of the openings 226a to 226c is an arcuate groove and forms a portion of an air channel W described later. Although omitted in FIG. 3, the openings 226a to 226c are provided in a plurality of rows (nine rows in the present embodiment). The number of rows is the same as the number of the chambers 223 divided in the width direction and the conveyance direction.

### <Connection Holes and Tubes>

As illustrated in FIG. 4, connection holes 227 that communicate with the respective openings 226a to 226c are provided in a surface of the conveyance drum 221 that faces the suction control plate 226. Inside the conveyance device 22, tubes 228 are disposed that include a plurality of channels. Each of the tubes 228 communicates with each of the chambers 223 in a region corresponding to each of the connection holes 227.

### (Tubes)

As illustrated in FIG. 4 and FIG. 5, tubes 50 include a plurality of channel members. A first end of each tube 50 is connected to each of the openings 226a to 226c. A second end of each tube 50 is connected to the suction device 60. The tube 50 includes a valve 51 and a buffer tank 52.

### <Valves>

The valve 51 includes an electromagnetic valve that can be opened and closed under the control of the controller 40. The valve 51 is preferably disposed at such a position that the volume of a space from the valve 51 to the suction device 60 (hereinafter referred to as a closed space CS) is larger than the volume of a space from the valve 51 to the suction holes H (hereinafter referred to as an open space OS). Specifically, the valve 51 is preferably disposed at such a position that the volume of the closed space CS is three times or more the volume of the open space OS. With this configuration, a sufficient negative pressure can be formed in the closed space CS in recording medium conveyance control described later.

It is preferable to use a valve 51 that has a sufficiently low channel resistance when open. The use of a valve 51 having a low channel resistance is preferable because the pressure in the air channel W, which will be described later, can be quickly equalized (saturated) after opening the valve 51 in the recording medium conveyance control.

### <Buffer Tanks>

The buffer tank 52 is disposed in the closed space CS of the tube 50, that is, between the valve 51 and the suction device 60. The buffer tank 52 includes, for example, a rigid sealed tank made of metal. In order to ensure the above-described volume of the closed space CS by the tube 50 alone, it is necessary to increase the length of the tube 50. Then, the channel resistance in the tube 50 increases, and it takes time to equalize the pressure after opening the valve 51 in the recording medium conveyance control. In addition, increasing the length of the tube 50 makes it difficult to organize the tube 50. Therefore, in the present embodiment, these problems are solved by providing the buffer tank 52.

### (Suction Device)

The suction device 60 includes, for example, a pump including a known fan and motor. The suction device 60 is driven under the control of the controller 40 to suction air in the tube 50.

With the above-described configuration, a single air channel W is formed from the chamber 223 to the suction device 60 in the suction region A1. The suction pressure generated by driving the suction device 60 generates a negative pressure in the chamber 223 whose upper surface is covered with the recording medium P. As a result, the recording medium P is attached onto the conveyance surface F having the plurality of suction holes H and held on the conveyance surface F even when the conveyance drum 221 is rotated.

### {Image Forming Section}

Returning to FIG. 1, the image forming section 23 forms an image on the recording medium P conveyed by the conveyance device 22. In the present embodiment, the image forming section 23 includes, for example, a plurality of head units each including a plurality of inkjet heads. Each head unit forms an image by ejecting ink of corresponding color from nozzle openings facing the conveyance surface F at an appropriate timing according to the rotation of the conveyance device 22 holding the recording medium P. The head unit is disposed such that the nozzle openings and the conveyance surface F are separated from each other by a predetermined distance.

### {Fixing Section}

The fixing section 24 fixes the image formed on the recording medium P by the image forming section 23. The fixing section 24 includes, for example, an energy ray irradiation section. Specifically, the fixing section 24 includes a light emitting unit disposed throughout the width of the conveyance device 22 in the width direction. Under the control of the controller 40, the light emitting unit irradiates the conveyed recording medium P with energy rays such as ultraviolet rays. Thus, the ink on the recording medium P is cured and fixed.

### {Conveyance Rollers}

The conveyance roller 25 receives the recording medium P, which has passed through the image forming section 23 and the fixing section 24, from the conveyance device 22 and conveys the recording medium P. As illustrated in FIG. 1, the conveyance rollers 25 include, for example, a first conveyance roller 251, a second conveyance roller 252, a third conveyance roller 253, and a fourth conveyance roller 254.

The first conveyance roller 251 is provided in such a manner as to face the conveyance device 22. The second conveyance roller 252 is provided in such a manner as to face the first conveyance roller 251. The third conveyance roller 253 and the fourth conveyance roller 254 are provided in such a manner as to face the second conveyance roller 252. Among these, the first conveyance roller 251, the third conveyance roller 253, and the fourth conveyance roller 254 rotate in a direction opposite to the conveyance direction. The second conveyance roller 252 rotates in the conveyance direction.

The first to fourth conveyance rollers 251 to 254 include claws 251a to 254a, respectively. The claws 251a to 254a open and close under the control of the controller 40. Specifically, the controller 40 delivers the first end of the recording medium P to the claws 252a, 253a, and 254a by respectively setting the claws 251a, 252a, and 252a to the open state at the timing of respectively delivering the recording medium P to the second conveyance roller 252, the third conveyance roller 253, and the fourth conveyance roller 254, which are respectively disposed downstream of the claws 251a, 252a, and 252a. The controller 40 also holds the first end of the recording medium P by setting the claws 252a, 253a, and 254a to the closed state at the timing of respectively delivering the first end of the recording medium P from the claws 251a, 252a, and 252a, which are respectively disposed upstream of the claws 252a, 253a, and 254a.

### {Belt Conveyance Section}

The belt conveyance section 26 is provided in such a manner as to face the third conveyance roller 253. The belt conveyance section 26 includes an annular conveyance belt whose inner side is supported by a plurality of rollers. The belt conveyance section 26 conveys the recording medium P delivered from the third conveyance roller 253 to a sheet ejection tray 31.

### {Swing Arm}

The swing arm 27 is disposed downstream of the fourth conveyance roller 254. When the image forming apparatus 1 performs double-sided printing, the fourth conveyance roller 254 and the swing arm 27 reverse a first side and a second side of the recording medium P and return the recording medium P to the conveyance device 22.

Specifically, upon completion of the image formation of the first side of the recording medium P, the controller 40 sequentially delivers the first end of the recording medium P to the first conveyance roller 251, the second conveyance roller 252, and the fourth conveyance roller 254. When the second end of the recording medium P comes to a position facing the swing arm 27, the controller 40 delivers the recording medium P from the fourth conveyance roller 254 to the swing arm 27. Next, when any one of the conveyance surfaces F comes to a position facing the swing arm 27, the controller 40 delivers the recording medium P to the conveyance device 22.

Note that the image forming apparatus main body 20 according to the present invention executes so-called alternating circulation control when images are to be formed on both the first side and the second side of the recording medium P. In the alternating circulation control, the image formations of the second, third, . . . recording media P are sandwiched between the image formations of the first side and the second side of the first recording medium P. When the image forming apparatus 1 adopts the alternating circulation control, the space between sheets can be reduced compared to the normal circulation method in which the image formations of the first side and the second side of the first recording medium P are performed continuously, and the productivity of double-sided printing can be increased.

### (Sheet Ejection Device)

The sheet ejection device 30 stores the recording medium P ejected from the image forming apparatus main body 20 until a user collects the recording medium P. The sheet ejection device 30 includes the sheet ejection tray 31 having a plate shape.

### (Controller)

The controller 40 controls the operation of each component constituting the image forming apparatus 1. As illustrated in FIG. 2, the controller 40 includes a central processing unit (CPU) 41, a random-access memory (RAM) 42, and a read only memory (ROM) 43.

The CPU 41 executes various kinds of arithmetic processing. Furthermore, the CPU 41 comprehensively controls the entire operation of the image forming apparatus 1. The RAM 42 provides a working memory space for the CPU 41 and stores temporary data. The ROM 43 is a storage device such as a hard disk drive (HDD) or a solid-state drive (SSD) and stores various control programs to be executed by the CPU 41, configuration parameters, and the like. Note that a rewritable nonvolatile memory such as an electrically erasable programmable read only memory (EEPROM) or a flash memory may be used instead of the ROM 43.

### (External Device)

An external device 2 includes, for example, a computer. The external device 2 supplies image data or the like of an image to be recorded by the image forming apparatus 1 to the controller 40.

### [Recording Medium Conveyance Control; Single-Sided Printing]

The recording medium conveyance control in the image forming apparatus 1 configured as described above will be described. First, the description will be limited to the case of single-sided printing in which an image is formed only on the first side of a recording medium P.

The controller 40 that has received print job data from the external device 2 first conveys a recording medium P from the sheet feed device 10 to the image forming apparatus main body 20. The controller 40 places the recording medium P on the conveyance surface F of the conveyance device 22 and attaches the recording medium P onto the conveyance surface F by suction of the suction device 60.

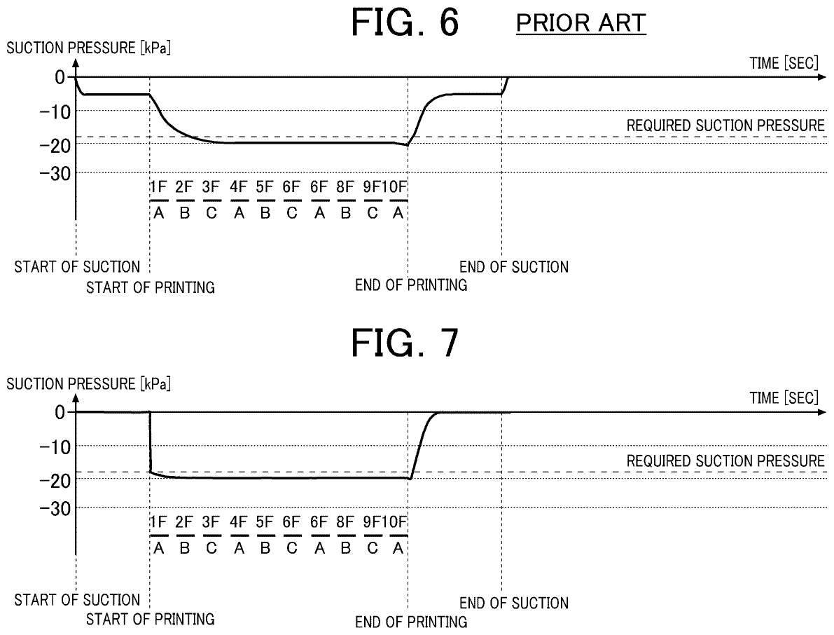

FIG. 6 is a graph summarizing recording media placed respectively on conveyance surfaces F in a conventional image forming apparatus 1 from the start of a print job and a measurement result of suction pressures of the conveyance surfaces F. As described above, in the image forming apparatus 1, the suction device 60 suctions air in the air channel W with the recording medium P placed on the conveyance surface F and a sealed space formed in the chamber 223, so that a negative pressure is formed in the chamber 223 and the recording medium P is attached onto the conveyance surface F. On the other hand, no recording medium P is placed on the conveyance surface F immediately after the start of a print job, and the suction holes H are open. As a result, as illustrated in FIG. 6, the formation of the negative pressure in the chamber 223 becomes insufficient, and the suction pressure on the conveyance surface F becomes high (i.e., the attachment force becomes weak). Therefore, in the conventional image forming apparatus 1, immediately after the start of a print job, a conveyance failure of the recording medium P or a printing failure due to lifting of the recording medium P tends to occur.

In contrast, before the start of conveyance of the recording medium P, the controller 40 according to the present embodiment closes the valve 51 and then drives the suction device 60 to form a negative pressure in the closed space CS. Then, before (preferably immediately before) the recording medium P blocks the suction holes H at the front end of the conveyance surface F in the conveyance direction, the controller 40 opens the valve 51 to form a suitable negative pressure in the chamber 223 from immediately after the start of a print job. Then, before (preferably immediately before) the recording medium P blocks the suction holes H at the front end of the conveyance surface F in the conveyance direction, the controller 40 closes the valve 51 to prevent the negative pressure of the air channel W from further increasing by the suction device 60. In the configuration of the present embodiment, as illustrated in FIG. 7, it is possible to convey the recording medium P while suctioning the recording medium P with a suitable suction pressure from the start of a print job.

The negative pressure a [kPa] formed in the closed space CS preferably satisfies a (c/(b+c))=d, where b:c is the ratio of the volume of the open space OS to the volume of the closed space CS, and d [kPa] is a suitable negative pressure in the air channel W during conveyance of the recording medium P.

For example, suppose that the volume (b) of the open space OS: the volume (c) of the closed space CS=1:4. Also suppose that a suitable negative pressure (d) in the air channel W during conveyance of the recording medium P is −18 kPa. In this case, when the valve 51 is opened, the open space OS is added to the closed space CS, so that the volume becomes 5/4 times larger than before the opening of the valve 51. On the other hand, the pressure becomes 4/5 times smaller than before the opening of the valve 51 because the chamber 223 in the open space OS communicated with the atmosphere and therefore the pressure in the open space OS was the atmospheric pressure. Therefore, it is found that after the opening of the valves 51, the pressure in the air channel W becomes a (4/5)=−18, and it is preferable to drive the suction device 60 such that the negative pressure a in the closed space CS is −22.5 kPa.

In addition, it is preferable that the controller 40 opens the valve 51 at such a timing that the time from the opening of the valve 51 to the placement of the recording medium P on the conveyance surface F is substantially the same as the time from the opening of the valve 51 to the equalization (saturation) of the pressure in the closed space CS. This is because when the valve 51 is opened too early, the air is released into the atmosphere through the suction holes H, and the negative pressure in the closed space CS becomes insufficient. Furthermore, when the valve 51 is opened too slowly, the recording medium P is conveyed with insufficient suction.

In addition, as illustrated in FIG. 3 and FIG. 5, when one conveyance surface F includes a plurality of regions, it is preferable that the controller 40 controls the opening and closing of the valve 51 according to the size of the recording medium P. This is because, for example, in a case where the size of the recording medium P in the width direction is small, when the valves 51 corresponding to the end chambers 2232 are opened, the end chambers 2232 are opened to the atmosphere.

In particular, when the plurality of valves 51 is opened, the controller 40 preferably opens the valve 51 corresponding to the center chamber 2231 at an earlier time (e.g., about 0.1 seconds earlier) than the valves 51 corresponding to the end chambers 2232. With the above-described configuration, the recording medium P is attached onto the conveyance surface F starting from the central portion of the recording medium P, thereby preventing a wrinkle from forming on the recording medium P.

### [Recording Medium Conveyance Control; Double-Sided Printing]

Next, a case where an image is formed on both sides of a recording medium P is described. As described above, the image forming apparatus 1 according to the present embodiment performs double-sided printing by the so-called alternating circulation control.

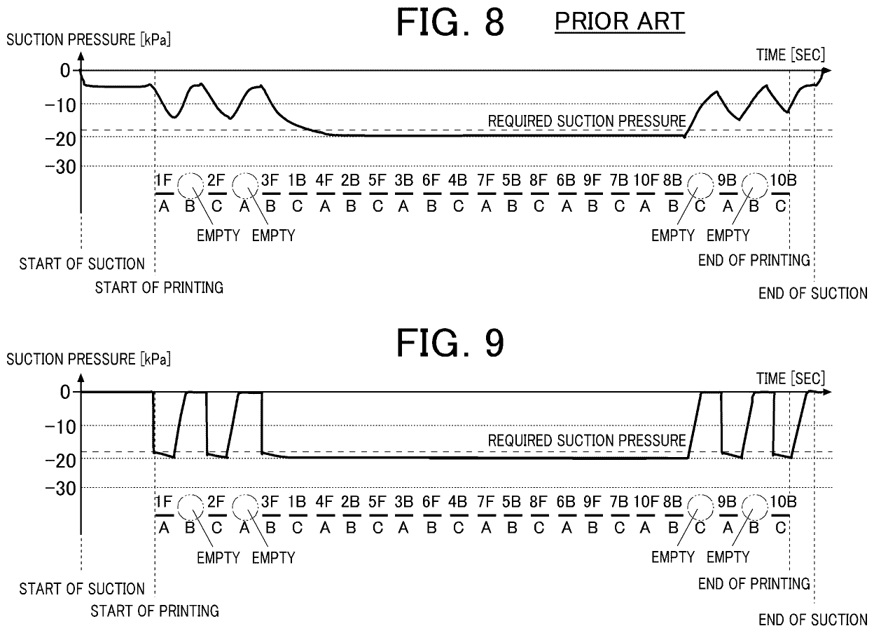

FIG. 8 is a graph summarizing recording media placed respectively on conveyance surfaces F in a conventional image forming apparatus 1 from the start of a print job and a measurement result of suction pressures of the conveyance surfaces F. As illustrated in FIG. 8, in the following example, it is assumed that double-sided printing is performed on recording media P of ten sheets.

In the alternating circulation control, the second (reversed) side of the recording medium P is placed on the conveyance surface F between the conveyance surfaces F on which the first sides of the recording media P are placed (for example, the surface C Fc, the surface A Fa, and the surface B Fb in this order). Therefore, at the start of double-sided printing, it is necessary to allow time for the second (reversed) side of the recording medium P to be placed on the conveyance surface F, and thus the recording media P cannot be continuously placed on the consecutive conveyance surfaces F, as illustrated in FIG. 8. As a result, the suction pressure on the conveyance surface F on which the recording medium P is not placed may increase, and the suction pressure on the subsequent conveyance surface F may not decrease sufficiently.

Furthermore, as illustrated in FIG. 8, the recording media P are not conveyed, i.e. not placed on the conveyance surfaces, at the end of double-sided printing in the alternating circulation control. Therefore, the recording media P cannot be continuously placed on the consecutive conveyance surfaces F. As a result, the suction pressure on the conveyance surface F on which the recording medium P is not placed may increase, and the suction pressure on the subsequent conveyance surface F may not decrease sufficiently.

However, the controller 40 according to the present embodiment forms a negative pressure in the closed space CS until the recording medium P is conveyed to the conveyance surface F and opens and closes the valve 51 before the recording medium P blocks the suction holes H. Therefore, as illustrated in FIG. 9, even in double-sided printing, a suitable suction pressure can be applied to the recording medium P at the time when the recording medium P is placed on the conveyance surface F to be conveyed.

According to the present embodiment, the recording medium can be instantaneously attached and conveyed with a suitable suction force.

### [Other Configurations]

Although specific description has been given above based on the embodiment according to the present invention, the present invention is not limited to the above-described embodiment. The present invention can be subjected to various modifications within the scope of the invention described in the claims and the equivalents thereof.

For example, in the above description, a configuration in which the valve 51 is provided in the tube 50 has been exemplified, but the present invention is not limited thereto. It is sufficient that the valve 51 be openable and closable under the control of the controller 40 in the air channel W formed between the suction device 60 and the chamber 223 and that a predetermined negative pressure be formed in the closed space CS by the time the recording medium P blocks the suction holes H and the valve 51 is opened. Therefore, for example, the valve 51 may be provided in the conveyance drum 221.

In addition, the suction force required on the conveyance surface F differs according to the characteristics of the recording medium P. Therefore, the controller 40 may function as an acquisition section that acquires information on the recording medium P. Then, the controller 40 may adjust the output of the suction device 60 according to the acquired information. For example, the controller 40 acquires information on, for example, the thickness and paper type of the recording medium P from print job data acquired from a sensor disposed upstream of the conveyance device 22 in the conveyance direction or from the external device 2.

As the negative pressure formed in the closed space CS increases, the time it takes for the pressure in the air channel W to be equalized after the valve 51 is opened increases. Therefore, when the controller 40 adjusts the output of the suction device 60 in accordance with the information on the recording medium P acquired from the acquisition section, the controller 40 may further adjust the opening timing of the valve 51.

In addition, in the above description, a configuration in which the conveyance surface F includes a plurality of regions in the conveyance direction and the width direction has been exemplified, but the invention is not limited thereto. The conveyance surface F may include a plurality of regions in a diagonal direction, for example.

In FIG. 1, one sheet feed device 10 including one sheet feed tray 11 is illustrated, but the present invention is not limited thereto. For example, one sheet feed device 10 may include a plurality of sheet feed trays 11. In addition, the image forming apparatus 1 may include a plurality of sheet feed devices 10. Similarly, in FIG. 1, one sheet ejection device 30 including one sheet discharge tray 31 is illustrated, but the present invention is not limited thereto. That is, the image forming apparatus 1 may include a plurality of sheet ejection trays 31.

In addition, in the above description, a case where the conveyance device 22 includes the conveyance drum 221 in which the conveyance surfaces F are disposed in the specific regions has been exemplified, but the present invention is not limited thereto. For example, the configuration of the present invention is applicable even when the conveyance device 22 includes an endless belt on its entire surface on which the recording medium P can be placed.

In the above description, an example in which a hard disk, a semiconductor nonvolatile memory, or the like is used as the computer-readable recording medium according to the present invention has been disclosed, but the present invention is not limited to this example. As another computer-readable recording medium, a portable recording medium such as a CD-ROM can be applied. Further, as a medium for providing data of the programs stored in the recording medium according to the embodiments of the present invention via a communication line, a carrier wave is also applied.

Although embodiments of the present invention have been described and shown in detail, the disclosed embodiments are made for purposes of illustration and example only and not limitation. The scope of the present invention should be interpreted by terms of the appended claims.

What is claimed is:

1. A conveyance device comprising:
a conveyance section that conveys a recording medium;
an air channel that communicates between a suction hole provided on a conveyance surface of the conveyance section and a suction section that suctions air;
a valve that divides the air channel into an open space containing the suction hole and a closed space containing the suction section when the valve is closed; and
a hardware processor that controls attachment of the recording medium onto the conveyance surface, wherein the hardware processor opens the valve when the recording medium blocks the suction hole.

2. The conveyance device according to claim 1, wherein
the air channel includes a channel member that allows the suction section and the conveyance section to communicate with each other, and
the valve is disposed in the channel member.

3. The conveyance device according to claim 1, wherein the valve is disposed in the air channel at a position closer to the conveyance section than the suction section.

4. The conveyance device according to claim 1, wherein the air channel includes a buffer tank in the closed space.

5. The conveyance device according to claim 1, wherein a volume of the closed space is larger than a volume of the open space.

6. The conveyance device according to claim 5, wherein the volume of the closed space is three times or more the volume of the open space.

7. The conveyance device according to claim 1, wherein the hardware processor opens the valve after a pressure in the closed space is saturated.

8. The conveyance device according to claim 1, wherein the hardware processor opens the valve before the recording medium blocks the suction hole.

9. The conveyance device according to claim 8, wherein the hardware processor closes the valve before the recording medium blocks the suction hole.

10. The conveyance device according to claim 1, wherein the hardware processor acquires information on the recording medium and
controls an output of the suction section according to the acquired information.

11. The conveyance device according to claim 10, wherein the hardware processor controls a timing of opening the valve according to the output of the suction section.

12. The conveyance device according to claim 1, wherein
the conveyance surface includes a plurality of regions,
the air channel includes a plurality of air channels corresponding to the respective plurality of regions, and
the valve includes a plurality of valves corresponding to the respective plurality of regions.

13. The conveyance device according to claim 12, wherein
the conveyance surface includes a plurality of regions in a width direction, and
the hardware processor opens the valve corresponding to a region, among the plurality of regions, corresponding to a central portion of the recording medium in the width direction before opening the valve corresponding to a region, among the plurality of regions, corresponding to an end portion of the recording medium in the width direction, the recording medium being placed on the conveyance surface.

14. The conveyance device according to claim 1, wherein
the conveyance section includes a conveyance drum that rotates to convey the recording medium placed on the conveyance surface, and
the suction section suctions the air through the suction hole provided only at a predetermined angular position.

15. An image forming apparatus comprising:
the conveyance device according to claim 1; and
an image forming section that forms an image on the recording medium.

16. A non-transitory computer-readable medium storing a computer-executable program, the program causing a computer of a conveyance device that includes:
a conveyance section that conveys a recording medium;
an air channel that communicates between a suction hole provided on a conveyance surface of the conveyance section and a suction section that suctions air; and
a valve that divides the air channel into an open space containing the suction hole and a closed space containing the suction section when the valve is closed to execute controlling attachment of the recording medium onto the conveyance surface, wherein the controlling includes opening the valve when the recording medium blocks the suction hole.
